(19) United States
(12) Patent Application Publication
(10) Pub. No.: US 2020/0326047 A1
(43) Pub. Date: Oct. 15, 2020

(54) RAIL ELEMENT FOR LIGHTING SYSTEMS AND LIGHTING SYSTEM COMPRISING SAID RAIL ELEMENT

(71) Applicant: ARTEMIDE S.p.A., Milano (IT)

(72) Inventors: Carlotta Francesca Isolina Maria DE BEVILACQUA, Milano (IT); Daniele MOIOLI, Milano (IT); Paolo LEONI, Milano (IT)

(21) Appl. No.: 16/843,502

(22) Filed: Apr. 8, 2020

(30) Foreign Application Priority Data
Apr. 9, 2019 (IT) 102019000005436

(51) Int. Cl. F21S 8/04

(52) U.S. Cl. CPC F21S 8/043

(57) ABSTRACT

A rail element for lighting systems comprises a bar body extending along a longitudinal axis and provided with a longitudinal inner channel along the axis and open on a front surface of the body; and a pair of opposite longitudinal insulating shells, housed in the channel along respective opposite lateral sides of the channel and extending parallel to each other and to the axis; each shell is provided with one or more conductive tracks extending along the respective channel parallel to the axis. The body has thickness of no more than 12.5 mm and can be bent around a bending axis, which is perpendicular to the axis.

### CROSS-REFERENCE TO RELATED APPLICATIONS

This patent application claims priority from Italian patent application no. 102019000005436 filed on Apr. 9, 2019, the entire disclosure of which is incorporated herein by reference.

### TECHNICAL FIELD

The invention relates to a rail element for lighting systems and to a lighting system comprising said rail element.

The invention is particularly suited to manufacture—by way of example, but not exclusively—linear lighting systems, namely lighting systems extending along a linear path, which is not necessarily straight, but can also follow different geometric shapes, in particular also curved ones.

### PRIOR ART

Among linear lighting systems, rail lighting systems are widely used. In known rail lighting systems, one or more lamps, for example of the spotlight type, are mounted on a longitudinal rail element, which is usually embedded in a ceiling.

Inside the rail elements there can also be LED strips, thus creating extended light effects instead of punctual light effects, which are typical of lamps and spotlights.

The rail elements normally consist of rigid elements, for example straight metal section bars. Therefore, the geometry of lighting systems of this type is limited to straight arrangements.

Even though curved rail elements can be manufactured, they need to be especially manufactured for each single purpose and be installed exactly in the original configuration, with no possibility of changes upon installation and set up of the lighting system.

In any case, then, known rail elements, for they have to house the cables needed to power and control the light sources, have dimensions, in particular a thickness or a height, which are relatively large and, anyway, exceed the standard thickness of plasterboard, which is used for the typical false ceilings where rail lighting systems are usually installed.

This leads to difficulties and complications in the set up and installation phase.

### SUBJECT-MATTER OF THE INVENTION

The object of the invention is to provide a rail element for lighting systems and a lighting system comprising said rail element which are not affected by the drawbacks of the prior art discussed above.

Hence, the invention relates to a rail element for lighting systems and to a lighting system comprising said rail element as defined, in essential terms, in appended claims 1 and 7, respectively.

Additional and preferred features of the invention are defined in the dependent claims.

The rail element according to the invention has a structure and a configuration which turn out to be particularly efficient and allow dimensions to be contained, in particular in terms of height, so as to also adapt to the standard sizes of usual plasterboard false ceilings, thus allowing the rail element to be installed without interventions for the adjustment of the false ceiling.

Then, the particular arrangement of the conductive tracks allows, always with extremely reduced sizes and dimensions, for the use of cables with a significant (i.e. relatively large) cross section, so as to avoid possible problems of voltage drops along the rail element.

Furthermore, the rail element is made of a material which is plastically cold-deformable, in particular can be bent, on the construction site, namely upon installation and, hence set up of the lighting system. The bending can be carried out by means of a hand-operated calender, namely in a simple, quick and precise manner.

Starting from a straight rail element, which is supplied by the factory, the desired curved shape can thus be directly obtained in the place where it has to be installed.

The rail element according to the invention can fit not only lighting devices of different types (lamps, spotlights, LED strips, etcetera), but also apparatuses and accessories of other types, such as sensors, speakers, etcetera.

The rail element according to the invention can be provided with a different number of conductive tracks, which be used, besides for the supply of power to the different devices installed on the rail element, for the transmission of data and, hence, for instance, for the control of the devices.

### BRIEF DESCRIPTION OF THE DRAWINGS

Further features and advantages of the invention will be best understood upon perusal of the following description of a non-limiting embodiment thereof, with reference to the accompanying drawing, wherein:

FIG. 1 is a schematic perspective view of rail lighting system according to the invention;

FIG. 2 is a cross section view of a rail element for lighting systems according to the invention.

### PREFERRED EMBODIMENT OF THE INVENTION

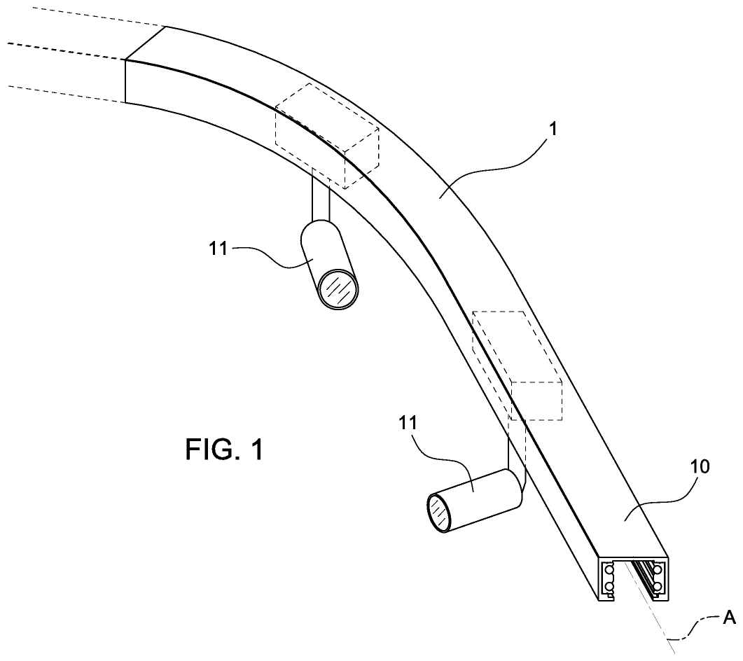

In FIG. 1, number 1 indicates a rail lighting system extending along a linear path or axis, not necessarily a straight one, but also following different geometric shaped, in particular even curved shapes.

The lighting system 1 comprises a rail element 10 and one or more lighting devices 11 (shown in FIG. 1 only schematically) supported by the rail element 10 and provided with light sources, for example lamps, spotlights, LED strips, etcetera.

It remains understood that the lighting system 1 can comprise a plurality of rail elements 10 connected to one another, as it is often the case for systems of this type. Therefore, the rail element 10 defines a modular element of the lighting system 1, which can be combined with other similar rail elements in order to form the lighting system 1, with the aid of joining elements (which are not shown).

Even though this is quite usual with rail elements, modularity means an electrical-mechanical connection with continuity between different rail portions.

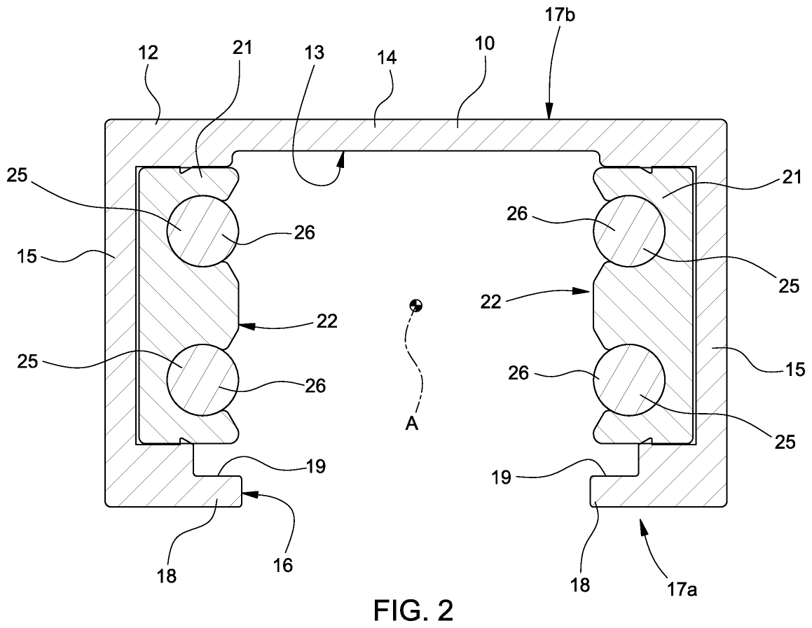

According to FIG. 2, more in detail, the rail element 10 comprises a bar body 12 extending along a longitudinal axis A.

The body 12 is a hollow body provided with a longitudinal inner channel 13 along the axis A, which is delimited by a bottom wall 14 and by two opposite lateral sides 15, which originate from respective sides of the bottom wall 14.

The channel 13 is provided with a front opening 16 made in a front surface 17a of the body 12 and longitudinally extending along the channel 13 and, hence, along the entire body 12. The opening 16 faces the bottom wall 14 and is laterally delimited by respective longitudinal edges 18, which project towards one another from respective sides 15.

In the non-limiting example disclosed herein, the body 12 has a substantially quadrangular cross section, in particular a rectangular cross section, and the bottom wall 14 is substantially perpendicular to the sides 15 and parallel to the edges 18.

It is however clear that the shape of the cross section of the body 12 can be different from the one described and show herein by mere way of example and the bottom wall 14, the sides 15 and the edges 18 can be differently shaped and oriented.

The body 12 preferably has a thickness of no more than 12.5 mm, measured as maximum distance between the front surface 17a where the opening 16 is formed and a rear surface 17b opposite it, which is defined by the outer surface of the bottom wall 14.

In the specific case shown herein, the opposite surfaces 17a, 17b are flat and parallel and, therefore, the thickness of the body 12 between the surfaces 17a, 17b is the same in any point of the surfaces 17a, 17b.

The edges 18 have respective inner recesses 19 facing the channel 13 ad extending along the edges 18 parallel to the axis A.

The channel 13 defines a seat for the lighting devices 11 (FIG. 1).

The recesses 19 define respective coupling seats, which can be engaged by respective coupling members of the lighting devices 11, which can optionally slide along the channel 13.

The body 12 is an extruded section bar made of aluminium or of an aluminium alloy, which is cold bendable by means of a hand-operated calender.

In particular, the body 12 (and, hence, the rail element 10 as a whole) can be bent around a bending axis, which is perpendicular to the axis A, so as to gain a curved shape along the axis A.

The possibility of bending the body 12 and, hence, the rail element 10 as a whole is the result of the thermal treatment to which the body 12 is subjected after the extrusion of the aluminium (also meaning aluminium alloy, as it is common in the field).

For example, the body 12 is made of annealed aluminium.

The body 12 is preferably provided in a T4 physical state (basically, without artificial ageing).

Materials of the 6XXX series, namely alloys with magnesium and silicon as main alloying elements, have proven to be suitable.

For example, the body 12 is made of EN AW-6060 aluminium, T4 state.

Hereinafter, by way of merely indicative and non-limiting example, are some minimum radii of curvature for maximum bending angles which can be obtained:

| radius of | |
|---|---|
| curvature | bending |
| (mm) | angle |
| 50 | 45° |
| 100 | 90° |
| 200 | 135° |
| 400 | 180° |

Therefore, the rail element 10 is manufactured and supplied to installers in a straight shape, namely with the body 12 extending along a straight axis A.

On the construction site or, anyway, in the place where the lighting system 1 has to be installed, the body 12 is bent to the desired shape, by means of a simple hand-operated calender.

Inside the channel 13, the rail element 10 houses a pair of longitudinal insulating shells 21, which extend parallel to the axis A and are made of an insulating material, for example a polymer material.

The shells 21 are housed in the channel 13 along respective sides 15 and extend parallel to one another and to the axis A; the shells 21 have respective faces 22 facing one another in the channel 13.

Each shell 21 is provided with or more conductive tracks 25, which extend along the channel 13 parallel to the axis A.

The tracks 25 are made of a conductor material, for example a metal material. The tracks 25 are, for example, in form of cables or bars.

Each track 25 is partially embedded in the respective shell 21 and projects from the face 22 of the shell 21, having an exposed portion 26, which longitudinally extends parallel to the axis A along the channel 13.

In the preferred embodiment shown herein, each shell 21 is provided with a pair of conductive tracks 25, which extend side by side one above the other and are separated by the insulating material of the shell 21.

Hence, the rail element 10 is provided with two pairs of conductive tracks 25 arranged along respective opposite lateral sides 15 of the channel 13. A pair of tracks 25 is used to electrically power the lighting devices 11 (namely, it supplies power), while the other pair of tracks 25 carries signals (data) to be used, for instance, for the control of the lighting devices 11.

The portions 26 are available to come into contact with electrical contacts of the lighting devices 11.

It is clear that, also based on the type of lighting devices 11 installed on the rail element 10, the rail element 10 can include a different number of tracks 26 arranged in a different manner from the one described and shown herein by mere way of example.

Given the lateral arrangement of the conductive tracks 26, they can have large cross sections, without jeopardizing the overall dimensions of the body 12 and of the rail element 1.

Finally, the rail element and the lighting system described and shown herein can be subjected to further changes and variants, which do not go beyond the scope of protection set forth in the appended claims.

1. A rail element (10) for lighting systems, comprising a bar body (12) extending along a longitudinal axis (A) and provided with an inner longitudinal channel (13) along the axis (A) and open on a front surface (17a) of the body (12); and a pair of opposite insulating shells (21), made of an insulating material and housed in the channel (13) along respective opposite lateral sides (15) of the channel (13) and extending parallel to each other and to the axis (A); each shell (21) being provided with one or more conductive tracks (25) extending along a respective side (15) of the channel (13) parallel to the axis (A).

2. A rail element according to claim 1, wherein each shell (21) is provided with a pair of conductive tracks (25) extending parallel to each other and one above the other and are separated by the insulating material of the shell (21).

3. A rail element according to claim 1, wherein the shells (21) have respective faces (22) facing towards each other in the channel (13); and each track (25) is partially embedded in the respective shell (21) and protrudes from the face (22) of the shell (21) facing the opposite shell (21), having an exposed portion (26) extending longitudinally parallel to the axis (A) along the channel (13).

4. A rail element according to claim 1, wherein the body (12) has a thickness not higher than 12.5 mm, measured as the maximum distance between opposite surfaces (17a, 17b) of the body (12).

5. A rail element according to claim 1, wherein the body (12) is an extruded section bar made of aluminum or aluminum alloy which is cold bendable by means of a manual calender.

6. A rail element according to claim 1, wherein the body (12) is made of annealed aluminum or aluminum alloy.

7. A lighting system (1) comprising a rail element (10) and one or more lighting devices (11) supported by the rail element (10); characterized in that the rail element (10) is a rail element according to claim 1.
